(19) United States
(12) Patent Application Publication
(10) Pub. No.: US 2013/0018755 A1
(43) Pub. Date: Jan. 17, 2013

(54) Method and System of Recommending Items

(71) Applicant: Wei Zhang, Hangzhou (CN)

(72) Inventor: Wei Zhang, Hangzhou (CN)

(73) Assignee: ALIBABA GROUP HOLDING LIMITED, Grand Cayman (KY)

(21) Appl. No.: 13/576,490

(22) PCT Filed: May 10, 2012
(86) PCT No.: PCT/US2012/037344

§ 371 Date: Aug. 1, 2012

(30) Foreign Application Priority Data
May 18, 2011 (CN) 201110130424.6

(51) Int. Cl. G06Q 30/00

(52) U.S. Cl. 705/26.7

(57) ABSTRACT

A recommendation system may acquire historic data associated with a user ID. The historic data may include multiple item IDs associated with the user ID. The recommendation system may calculate first multiple correlations between an item ID of the multiple item IDs and other IDs of the multiple item IDs based on the historic data. The first multiple correlations may be used to determine multiple correlated item IDs associated with the item ID. Using the multiple correlated item IDs, the recommendation system may align a user-item scoring matrix to generate an aligned scoring matrix. The aligned scoring matrix may be used to determine a recommended item collection.

### CROSS REFERENCE TO RELATED PATENT APPLICATIONS

This application is a national stage application of an international patent application PCT/US12/37344, filed May 10, 2012, which claims priority to Chinese Patent Application No. 201110130424.6, filed on May 18, 2011, entitled “Method and System of Recommending Items,” which applications are hereby incorporated by reference in their entirety.

### TECHNICAL FIELD

This disclosure relates to the field of item recommendation. More specifically, the disclosure relates to a method and a system for recommending items.

### BACKGROUND

Recommendation systems generally produce a list of recommendations in response to queries to help users discover items they might not have been found simply by searches. However, websites associated with e-business provide a huge number of items. Compared to the number of items available and viewed, the number of items that are purchased or rated by a user is relatively small. This asymmetry may present some problems for item recommendations using conventional technologies. For example, under conventional technology, item recommendations are sometimes not accurate, and the coverage of recommendation results is small.

### SUMMARY OF THE DISCLOSURE

This disclosure provides a method and a system for recommending items based on user historic data. The historic data associated with a user identifier (ID) may be acquired. The historic data may include multiple item identifiers (IDs) associated with the user ID. Based on the historic data, a bipartite graph may be generated to calculate first multiple correlations between an item ID and other item IDs in the bipartite graph. The first multiple correlations may be used to identify correlated item IDs that correlate with the item ID. The correlated item IDs may be used to align a user-item scoring matrix, which is generated based on the historic data. Based on the aligned scoring matrix, second multiple correlations may be calculated between an item ID and other IDs in the scoring matrix. The second multiple correlations may then be used to generate a recommended item collection.

### BRIEF DESCRIPTION OF THE DRAWINGS

The Detailed Description is described with reference to the accompanying figures. The use of the same reference numbers in different figures indicates similar or identical items.

FIG. 1 is a block diagram of an illustrative architecture that supports item recommendations.

FIG. 2 is a flow diagram of an illustrative process to generate a query result including item recommendations.

FIG. 3 is a flow diagram of an illustrative process to determine a recommended item collection based on user historic data.

FIG. 4 is an illustrative bipartite graph that is used to illustrate an example of correlated item ID determination.

FIG. 5 is a block diagram of an illustrative computing device that may be deployed in the environment shown in FIG. 1.

### DETAILED DESCRIPTION

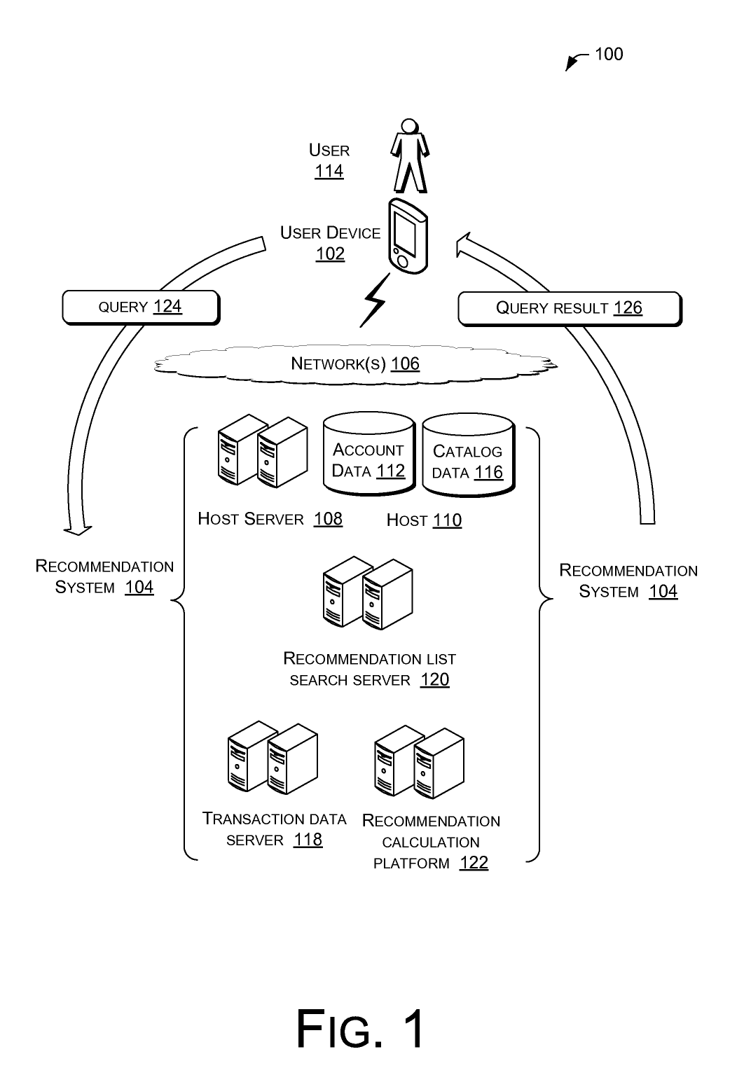

FIG. 1 is a block diagram of an illustrative architecture 100 that supports item recommendations. The architecture 100 may include a user device 102 and a recommendation system 104. The user device 102 may connect to one or more networks 106 to exchange information with the recommendation system 104. The recommendation system 104 may include a host server 108 of a host 110 that stores account data 112 for a user 114 and catalog data 116 for various items (e.g., goods and services). In some embodiments, the recommendation system 104 may also include a transaction data server 118, a recommendation list search server 120, and a recommendation calculation platform 122.

The transaction data server 118 may store historic data regarding transactions associated with the user 114. In some embodiments, the historic data may include multiple user IDs associated with multiple users and corresponding item IDs associated with items that these users have purchased or viewed. Based on the historic data, the recommendation calculation platform 122 may generate a recommendation for the user 114. The newly generated recommendation may update an existing recommendation stored in the recommendation list search server 120. In some embodiments, functionalities of the transaction data server 118, the recommendation list search server 120, and the recommendation calculation platform 122 may be implemented by the host server 108.

In some embodiments, the user 114 may use a transaction account to purchase one or more items from, or to interact with, the host 110. The user 114 may, via the user device 102, submit a query 124 to the host server 108 of the recommendation system 104. In some embodiments, the host server 108 may transmit a request to the recommendation list search server 120 that may search based on the request and return a recommendation to the host server 108. Based on the recommendation, the host server 108 may generate a query result 126 and transmit the query result 126 to the user device 102.

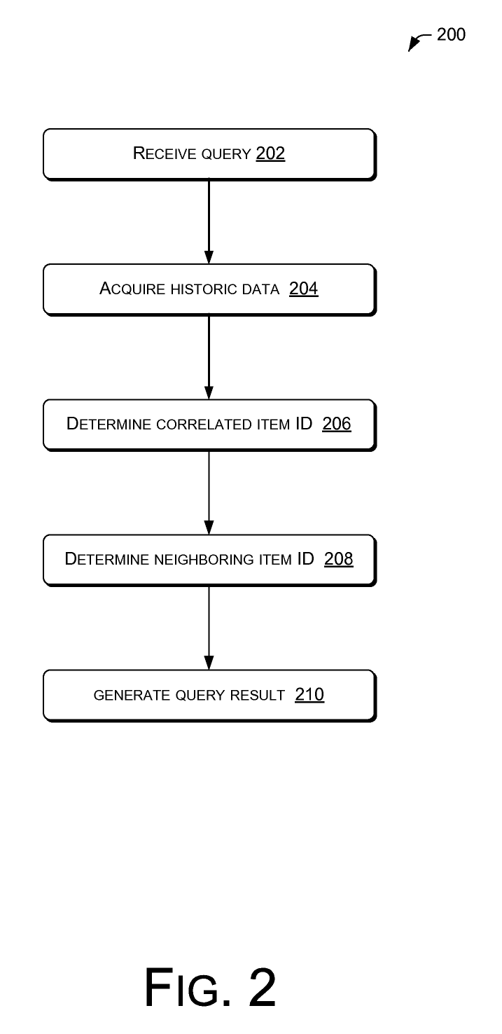

FIG. 2 is a flow diagram of an illustrative process 200 to generate a query result including item recommendations. At 202, the recommendation system 104 may receive the query 124 from the user device 102 to request recommendations associated with an item. At 204, the recommendation system 104 may parse the query to identify a user ID of the user 114 and acquire historic data associated with the user ID. The historic data may include multiple item IDs corresponding to the user ID. In some embodiments, the historic data may include multiple user IDs associated with multiple users and corresponding item IDs associated with items that these users have purchased or reviewed. The multiple item IDs may correspond to multiple items that users has purchased during transactions with the host 110. In some embodiments, the multiple items IDs may correspond to multiple items that the users has shown interest in (e.g., reviewed) while interacting with the host 110.

Based on the historic data, the recommendation system 104 may determine correlations between an item ID with other item IDs included in the historic data at 206. The correlations may be determined between two item IDs (e.g., every two item IDs). In some embodiments, for an item ID, the recommendation system 104 may designate a predetermined number of item IDs as correlated item IDs with the item ID. In these instances, the item IDs may have greater correlations than the rest of the item IDs.

At 208, the recommendation system 104 may determine neighboring item IDs of the item ID using the correlated item IDs. In some embodiments, the recommendation system 104 may generate a user-item scoring matrix based on the historic data. The user-item scoring matrix may then be aligned using the correlated item IDs. The aligned user-item matrix may be used to determine a recommended item collection.

At 210, the recommendation system 104 may generate the query result 126 based on the recommended item collection. The query result 126 may be transmitted to and displayed on the user device 102.

In some embodiments, the correlated item IDs can be obtained from different users and the alignment can fill in the sparse user-item scoring matrix. Accordingly, reliabilities of correlation calculation between item IDs is increased. The correlation between some potential related item IDs, which cannot be calculated because of the sparse data in the matrix in the conventional solution, can be created. Hence, inaccurate recommendation results due to not enough directly correlated item IDs corresponding to each user or potentially correlated items that could not have correlation can be improved. Therefore, the recommendation results of the recommendation system for items are enhanced. Further, due to the increase of the accuracy of the recommendation results, the user 114 can get the information of items of his/her interests without conducting unnecessary search or browsing operations, as conventional technologies might require. Consequently, occupation of the bandwidth between the user device 102 and the host server 108 can be reduced, and data transmission speed is increased, increasing data transmission efficiency.

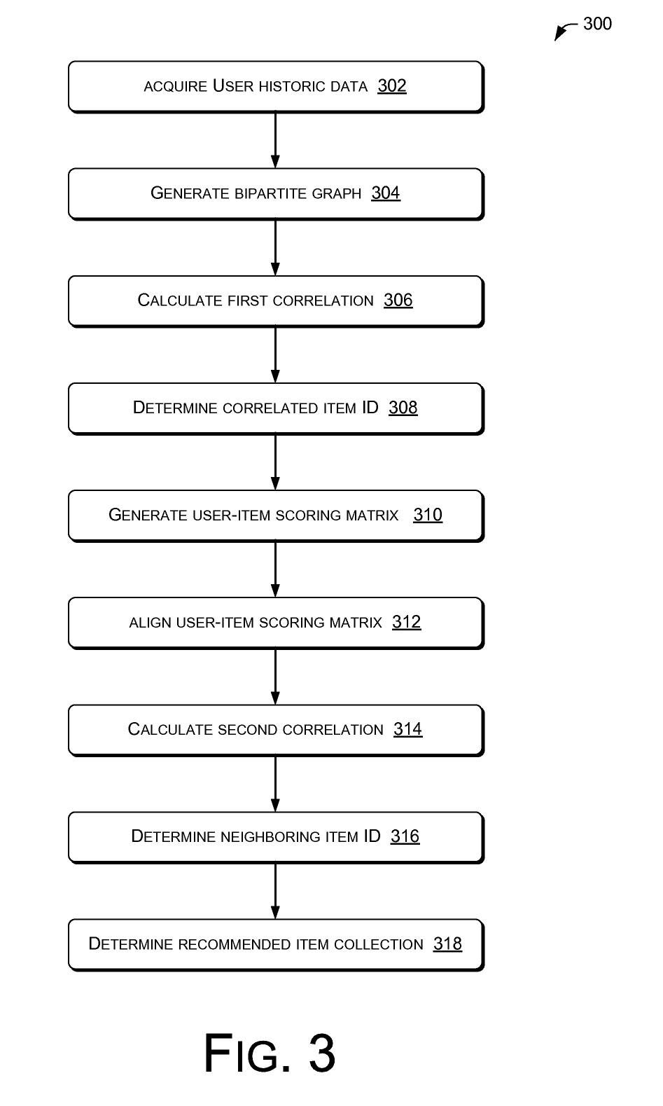

FIG. 3 is a flow diagram of an illustrative process 300 to determine recommended item collection based on user historic data. At 302, the recommendation system 104 may acquire historic data associated with users. The historic data may include the user ID and item IDs corresponding to the user ID. In some embodiments, the historical data may include the user ID and the item IDs corresponding to items that the users have purchased. In some embodiments, the historic data may include multiple user IDs associated with multiple users and corresponding item IDs associated with items that these users have purchased or reviewed. In some embodiments, the item IDs may correspond to items in which the users have shown interest. For example, while interacting with the host, the users have reviewed certain items, which may correspond to the item IDs for the historic data.

At 304, based on the historic data, the recommendation system 104 may generate a user-item bipartite graph based on the historic data. In some embodiments, the bipartite graph may be based on the corresponding relationships between the user IDs and item IDs included in the historical data. While creating the user-item bipartite graph, the recommendation system 104 may designate the user IDs and the item IDs as vertices in the bipartite graph and create an edge between the user ID vertex and an item ID vertex. The bipartite graph may be illustrated as a topology.

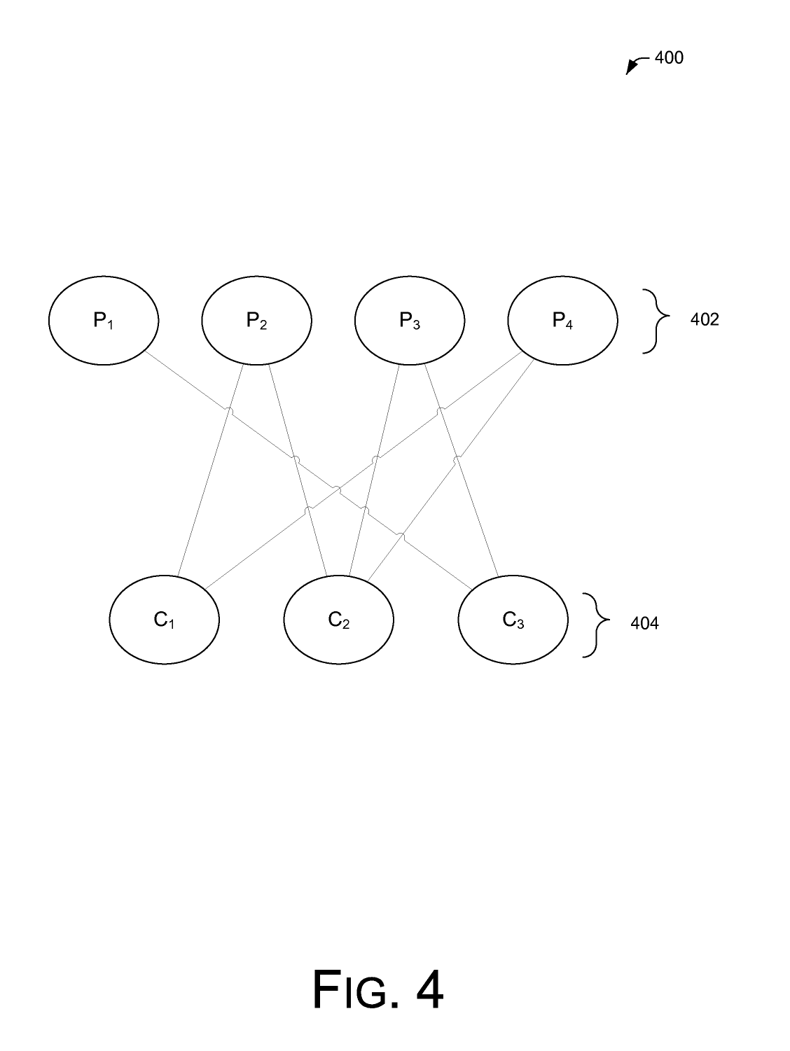

For example, FIG. 4 is an illustrative bipartite graph 400 that is used to illustrate an example of a correlated item ID determination. As shown in FIG. 4, the upper level nodes p₁˜p₄ are item vertices 402 associated with the item IDs, while the lower level nodes c₁˜c₃ are user vertices 404 associated with the user IDs. The lines between the user IDs vertices 404 and the item IDs 402 vertices may indicate that the user IDs vertices and the item IDs vertices have corresponding relationships in the historical data.

With reference again to FIG. 3, at 306, the recommendation system 104 may calculate correlations between two item IDs based on the bipartite graph. The recommendation system 104 may calculate a sum of the correlations of edges (e.g., all edges) between vertices corresponding to the two items, and designate the sum as the correlation between the two item vertices. For example, the correlation of an edge between the two item vertices is a^{m}, where “a” is the impact factor of an edge length. In some embodiments, the “a” may be a real number between zero and one (i.e., 0-1, for example a=0.8), that may be obtained in conjunction with application data. The “m” is a length of a corresponding edge. In some embodiments, the length of an edge in the bipartite graph can be set as 1, and the “m” may be determined based on the number of edges between two item vertices.

In some embodiments, the user-item bipartite graph may contain multiple user IDs and item IDs, as shown in FIG. 4. The recommendation system 104 may calculate a correlation of edges between two item IDs whose edge lengths are smaller than the biggest edge length that is calculated, and the correlation between the two item vertices is obtained by a summing operation. For example, the biggest path length may be set, but not limited, to six (6).

At 308, the recommendation system 104 may determine one or more correlated item IDs of an item ID based on the calculated correlations. In some embodiments, the recommendation system 104 may determine multiple correlated item IDs for each of the item IDs that are associated with the user IDs of the users. In some embodiments, the recommendation system 104 may limit as the number of correlated item IDs corresponding to an item ID to a predetermined number. In these instances, the predetermined number of item IDs captures the best correlations with an item ID as compared to the remaining item IDs beyond the predetermined number. The predetermined number may be set as, for example, 20, 35, etc.

At 310, the recommendation system 104 may, based on the historic data, generate a user-item scoring matrix. In some embodiments, the recommendation system may predetermine a user as a row of the user-item scoring matrix and an item as a column of the matrix. In these instances, the value of an element or cell of the user-item scoring matrix may be determined depending on whether a corresponding relationship between the user ID and the item ID exists in the historical data. For example, the element or cell value in the user-item scoring matrix may be designated as “1” when the corresponding relationship exists and as “0” when the corresponding relationship does not exist.

At 312, the recommendation system 104 may align the user-item scoring matrix using the correlated item IDs to generate an aligned user-item scoring matrix. The recommendation system 104 may determine that a corresponding relationship exists between the correlation of an item ID and the user ID, and then amend the corresponding element in the original user-item scoring matrix. That is, where a corresponding relationship is found, the element or cell in the matrix may be updated from a “0” to a “1”. Therefore, the aligned user-item scoring matrix may be obtained.

At 314, the recommendation system 104 may calculate correlations between two item IDs based on the aligned user-item scoring matrix. In some embodiments, a cosine correlation may be used to represent a correlation between two item IDs. For example, the cosine correlation between two items may be calculated based on the equation below.

$$cos ( {x}_{u} , {x}_{v} ) = \frac{{\sum }_{i ∈ {I}_{uv}}^{ } {r}_{ui} {r}_{vi}}{\sqrt{{\sum }_{i ∈ {I}_{u}}^{ } {r}_{ui}^{2} {\sum }_{j ∈ {I}_{v}}^{ } {r}_{vj}^{2}}}$$

In this equation, Xu and Xv are item ID column vectors corresponding to two item IDs u and v; Iᵤ and Iᵥ are user collections scoring u and v, respectively; Iᵤᵥ is a user collection scoring u and v; and rᵤᵢ is a user i collection scoring u.

At 316, the recommendation system 104 may determine one or more neighboring item IDs for an item ID based on the calculated correlations. In some embodiments, the recommendation system 104 may designate a predetermined number of item IDs as the neighboring item IDs for an item IDs. In these instances, the predetermined number of item IDs may be item IDs having greater correlations with the item ID than the rest of the item IDs.

In some embodiments, the recommendation system 104 may generate a candidate collection including a set of neighboring item IDs corresponding to the user IDs of the users. In these instances, the recommendation system may also remove item IDs that have corresponding relationships with the users in the user-item scoring matrix from the candidate collection. The recommendation system 104 may calculate the recommendation strength of each item ID in the candidate collection based on the correlations between item IDs corresponding to the user IDs of the users and the neighboring item IDs. The recommendation strength of a candidate collection can be calculated based on the equation below.

$${\hat{r}}_{ui} = \frac{{\sum }_{j ∈ {N}_{u} ( i )}^{ } {w}_{ij} {r}_{uj}}{{\sum }_{j ∈ {N}_{u} ( i )}^{ } \vert {w}_{ij} \vert}$$

In this equation, \hat{r}ᵤᵢ refers to the recommendation strength of user ID u for item ID i (or the prediction rating of the user ID u for the item ID i); rᵤⱼ refers to the real score that the user ID u gives to the item ID i; and wᵢⱼ indicates the cosine correlation between item ID i and item ID j.

At 318, the recommendation system 104 may determine a recommended item collection based on the neighboring item IDs. In some embodiments, the recommendation system 104 may select a predetermined number of item IDs having the highest recommendation strength in the candidate collection to constitute a recommended item collection for the user 114.

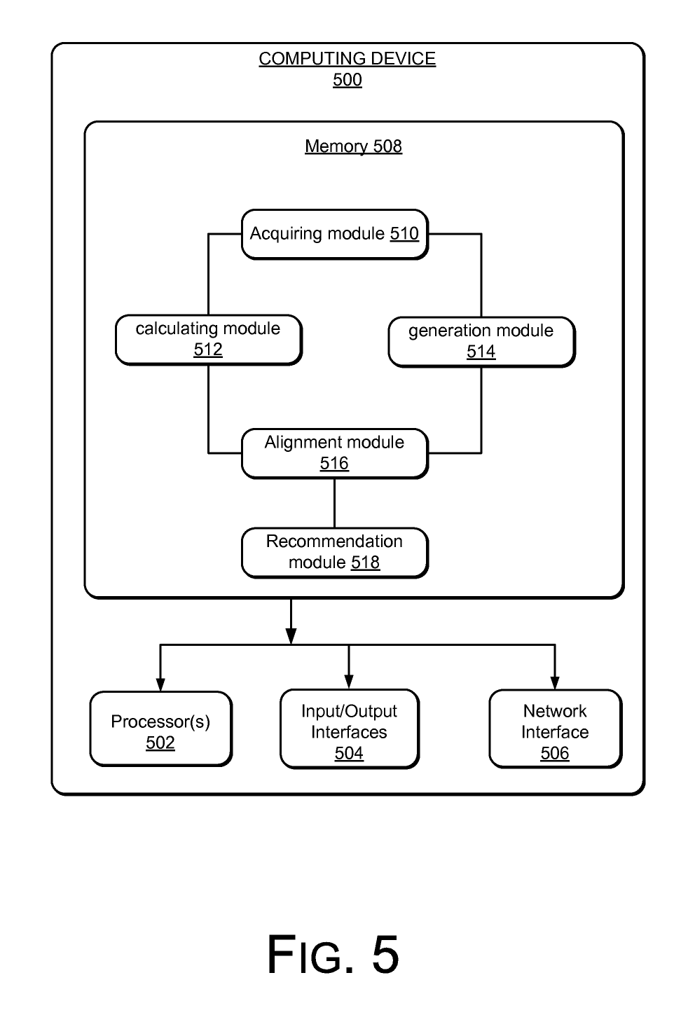

FIG. 5 is a block diagram of an illustrative computing device 500 of various components included in the computing environment of FIG. 1. The recommendation system 104 may be configured as any suitable server(s). In one exemplary configuration, a suitable server includes one or more processors 502, input/output interfaces 504, network interface 506, and memory 508.

The memory 508 may include computer-readable media in the form of volatile memory, such as random-access memory (RAM) and/or non-volatile memory, such as read only memory (ROM) or flash RAM. The memory 1008 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include transitory media such as modulated data signals and carrier waves.

Turning to the memory 508 in more detail, the memory 508 may store an obtaining module 510, a calculating module 512, a generation module 514, an alignment module 516 and a recommendation module 518. The obtaining module 510 may acquire the historical data of the users. The historical data may include a relationship between user IDs of the users and item IDs.

The calculating module 512 may calculate correlations between two item IDs based on the historical data. For each item ID, the calculating module 512 may determine a predetermined number of item IDs having the highest collections with the item ID as correlated item IDs of the item ID. In some embodiments, the calculating module 512 may designate a user ID and item ID in the historical data as vertices, and generate a direct edge between vertices corresponding to the user ID and item ID that have a corresponding relationship such as to generate a user-item bipartite graph.

In some embodiments, the calculating module 512 may calculate a correlation between two item IDs based on the created user-item bipartite graph. In some embodiments, the calculating module 512 may determine a predetermined number of item IDs having the higher related search correlation with an item ID as correlated item IDs of the item than other item IDs. In some embodiments, the calculating module may calculate a sum of correlations of edges (e.g., all edges) between vertices corresponding to the two item IDs and designate the calculated result as the correlation between the two item ID vertices.

The generation module 514 may generate an original user-item scoring matrix based on the historical data of the users.

The alignment module 516 may align the original user-item scoring matrix using the correlations to generate an aligned user-item scoring matrix. In some embodiments, the alignment module 516 may traverse the original user-item scoring matrix to determine whether corresponding relationship exists between the correlated item IDs and the user ID. If so, the alignment module 516 may amend the corresponding element in the original user-item scoring matrix.

The recommendation module 518 may determine a recommended item collection based on the scoring matrix. In some embodiments, the recommendation module 518 may calculate a correlation between two item IDs according to the aligned user-item scoring matrix. The recommendation module 518 may determine a predetermined number of item IDs having the higher correlations with an item as neighboring item IDs of the item ID based on the correlation.

In some embodiments, the recommendation module 518 may determine a recommended item collection based on the corresponding relationship between the user ID and the item ID, and the neighbor items of the item ID. The recommendation module 518 may generate an item candidate collection of the users based on the neighboring item IDs corresponding to the users. In these instances, the recommendation module 518 may remove item IDs that have corresponding relationship with the user ID in the original user-item scoring matrix.

In some embodiments, the recommendation module 518 may calculate a recommendation strength of each item ID in the item candidate collection based on correlations between items corresponding to the user ID and the neighboring item IDs. The recommendation module 518 may select a predetermined number of items having the higher recommendation strength in the item Candidate collection to generate the recommended item collection.

As such, the reliability of the correlation calculation between item IDs is increased. The correlation between some potential related item IDs, which cannot be calculated because of the sparse data in the array in the conventional solution, can be calculated according to this disclosure. Hence the inaccurate recommendation result resulted from the few direct related item of each user ID or the potential related items ID, which cannot be have correlation, can be improved. Thus, the recommendation result of the recommendation system for items is enhanced. Further, due to the increase of the accuracy of the recommendation result, the user can get the information of items of his/her interest without conduct unnecessary searching and browsing operations, as the conventional technology does. Consequently, the occupation of bandwidth between the user terminal of the user and the e-business website which is caused by the finding operations, such as searching browsing, can be reduced. Thus, the data transmission speed between the e-business website and the user terminal is increased, and so is the data transmission efficiency.

The embodiments in this disclosure are merely for illustrating purposes and are not intended to limit the scope of this disclosure. A person having ordinary skill in the art would be able to make changes and alterations to embodiments provided in this disclosure. Any changes and alterations that persons with ordinary skill in the art would appreciate fall within the scope of this disclosure.

What is claimed is:

1. One or more computer-readable media storing computer-executable instructions that, when executed by one or more processors, performs acts comprising:
acquiring historic data associated with user identifiers (IDs), the historic data including multiple item identifiers (IDs) associated with the user IDs;
calculating, based on the historic data, first multiple correlations between an item ID of the multiple item IDs and a plurality of item IDs of the multiple item IDs;
determining one or more correlated item IDs associated with the item ID based on the first multiple correlations;
generating a user-item scoring matrix based on the historic data, the user-item scoring matrix associating user IDs with item IDs;
aligning the user-item scoring matrix by using the one or more correlated item IDs to generate a aligned user-item scoring matrix; and
determining a recommended item collection based on the aligned user-item scoring matrix.

2. The one or more computer-readable media of claim 1, wherein the acts further comprise:
receiving a query; and
generating a query result based on the recommended item collection and the received query.

3. The one or more computer-readable media of claim 1, wherein the acts further comprise generating a bipartite graph based on the historic data, and wherein the calculating the first multiple correlations comprises calculating the multiple correlations based on the bipartite graph.

4. The one or more computer-readable media of claim 1, wherein the determining the recommended item collection comprises:
calculating second multiple correlations between one item ID and a plurality of item IDs in the aligned user-item scoring matrix;
determining a neighboring item ID of the one item ID based on the second multiple correlations; and
determining the recommended item collection based on the neighboring item ID associated with the one item ID.

5. The one or more computer-readable media of claim 4, wherein the determining the neighboring item ID comprises determining a predetermined number of neighboring item IDs having greater correlations with the one item ID than other item IDs in the aligned user-item scoring matrix.

6. The one or more computer-readable media of claim 1, wherein the determining the one or more correlated item IDs comprises determining a predetermined number of correlated item IDs having greater correlations with the item ID than other item IDs of the multiple IDs.

7. A computer-implemented method comprising:
acquiring historic data associated with user identifiers (IDs), the historic data including multiple item identifiers (IDs) associated with the user IDs;
generating a user-item scoring matrix based on the historic data, the user-item scoring matrix associating the user IDs with the item IDs;
aligning the user-item scoring matrix based on correlations among the multiple item IDs in the matrix; and
determining a recommended item collection based on the aligned user-item scoring matrix.

8. The computer-implemented method of claim 7, further comprising:
receiving a query from a device;
generating a query result based on the recommended item collection and the received query; and
transmitting the query result to the device.

9. The computer-implemented method of claim 7, wherein the generating the user-item scoring matrix comprises generating the user-item scoring matrix based on corresponding relationships between the user IDs and multiple item IDs.

10. The computer-implemented method of claim 7, further comprising:
generating a bipartite graph based on the historic data; and
calculating, based on the bipartite graph, first multiple correlations between an item ID of the multiple item ID and other item IDs of the multiple item IDs.

11. The computer-implemented method of claim 10, wherein the bipartite graph includes:
multiple vertices representing the users IDs and the multiple item IDs, and
multiple edges representing particular correlations between the user IDs and the multiple item IDs.

12. The computer-implemented method of claim 10, further comprising:
determining one or more correlated item IDs of the item ID based on the first multiple correlations; and
the aligning the user-item scoring matrix is performed based on these first multiple correlations.

13. The computer-implemented method of claim 12, wherein the determining the recommended item collection comprising:
calculating second multiple correlations between one item ID and other item IDs of the aligned user-item scoring matrix;
determining a neighboring item ID of the one item ID based on the second multiple correlations; and
determining the recommended item collection based on the neighboring item ID associated with the item ID.

14. The computer-implemented method of claim 7, wherein the multiple item IDs corresponding to multiple items that have been purchased or viewed via the user IDs.

15. A computer-implemented method comprising:
acquiring user historic data corresponding to user IDs, the historic data including multiple item IDs;
calculating first multiple correlations between an item ID and a plurality of item IDs of the multiple item IDs;
determining multiple correlated item IDs correlated with the item ID based on the first multiple correlations;
determining multiple neighboring item IDs associated with one item ID based on the historic data and the multiple correlated item IDs; and
determining a recommended item collection based on the multiple neighboring item IDs.

16. The computer-implemented method of claim 15, wherein the determining multiple correlated item IDs comprises:
generating a bipartite graph based on the historic data; and
determining multiple correlated item IDs based on the bipartite graph.

17. The computer-implemented method of claim 16, wherein the determining the multiple neighboring item IDs comprises:
generating a user-item scoring matrix based on the historic data;
aligning the user-item scoring matrix using the multiple correlated item IDs;
calculating second multiple correlations between the one item ID and multiple item IDs in the user-item scoring matrix; and
determining the multiple neighboring item IDs based on the second multiple correlations.

18. The computer-implemented method of claim 15, wherein the determining the multiple correlated item IDs comprises determining a predetermined number of correlated item IDs having greater correlations with the item ID than other item IDs of the multiple IDs.

19. The computer-implemented method of claim 15, wherein the determining the multiple neighboring item IDs comprises determining a predetermined number of neighboring item IDs having greater correlations with the one item ID than other item IDs of the multiple item IDs.

20. The computer-implemented method of claim 15, wherein the historic data further includes a plurality of items that has been purchased or reviewed via the user IDs.
